(19) United States
(12) Patent Application Publication
(10) Pub. No.: US 2024/0363851 A1
(43) Pub. Date: Oct. 31, 2024

(54) LITHIUM ION SECONDARY BATTERY

(71) Applicant: Prime Planet Energy & Solutions, Inc., Tokyo (JP)

(72) Inventor: Ryo HANAZAKI, Kobe-shi (JP)

(21) Appl. No.: 18/637,451

(22) Filed: Apr. 17, 2024

(30) Foreign Application Priority Data
Apr. 26, 2023 (JP) 2023-072404

(51) Int. Cl. H01M 4/525; H01M 4/131; H01M 4/133; H01M 4/36; H01M 4/587; H01M 10/0525

(52) U.S. Cl. CPC H01M 4/525; H01M 4/131; H01M 4/133; H01M 4/364; H01M 4/587; H01M 10/0525

(57) ABSTRACT

A technique disclosed herein relates to a lithium ion secondary battery. The positive electrode includes a positive electrode active material layer that contains a positive electrode active material. The positive electrode active material is a lithium-transition metal complex oxide that contains Li, Ni, and Mn, and that has a layered structure. In the lithium-transition metal complex oxide, a containing rate of the Ni with respect to metal elements other than the Li is equal to or more than 75 mol %. The negative electrode includes a negative electrode active material layer that contains a negative electrode active material. The negative electrode active material contains a carbon material and a Si containing material. In the positive electrode active material, a containing rate (mol) of a Co element and a containing rate (mol) of a Mn element satisfy a following relation: 0≤Co/Mn≤0.43.

### CROSS REFERENCE TO RELATED APPLICATIONS

This application claims the benefit of priority to Japanese Patent Application No. 2023-072404 filed on Apr. 26, 2023. The entire contents of this application are hereby incorporated herein by reference.

### BACKGROUND

The present disclosure relates to a lithium ion secondary battery.

The lithium ion secondary battery is suitably used as a power supply for driving that is mounted on a vehicle, such as hybrid vehicle (HEV), plug-in hybrid vehicle (PHEV), and electric vehicle (BEV), and a demand of it is rapidly expanding. As a positive electrode active material used on the lithium ion secondary battery, it is possible to use lithium-transition metal complex oxides, and it is possible, among them, to use a lithium nickel cobalt manganese type composite oxide that contains Ni, Co and Mn as shown in Japanese Unexamined Patent Application Publication No. 2017-191662.

### SUMMARY

On the other hand, recently, as the demand of the lithium ion secondary battery is expanding, a depletion of cobalt (Co) used for the lithium ion secondary battery is worried. As a counterplan for the matter described above, it can be thought to decrease a containing rate of Co in a positive electrode active material. However, as a result of an intensive study performed by the present inventor, a problem has been found that, in a case where a containing rate of Co in the positive electrode active material is decreased, a resistance increase at a storing time of the lithium ion secondary battery becomes significant.

A technique disclosed herein has been made in view of the above-described circumstances, and has an object to provide a lithium ion secondary battery in which the cobalt content amount of the positive electrode active material can be decreased and whose resistance increase at the storing time is inhibited.

A technique disclosed herein relates to a lithium ion secondary battery, characterized by comprising a positive electrode; a negative electrode; a separator; and a nonaqueous electrolyte, wherein the positive electrode comprises a positive electrode active material layer that contains a positive electrode active material, the positive electrode active material is a lithium-transition metal complex oxide that contains Li, Ni, and Mn and that has a layered structure, on the lithium-transition metal complex oxide, a containing rate of the Ni is equal to or more than 75 mol % with respect to a total of metal elements other than the Li, the negative electrode comprises a negative electrode active material layer that contains a negative electrode active material, the negative electrode active material contains a carbon material and a Si containing material, in the positive electrode active material, a containing rate (mol) of a Co element and a containing rate (mol) of a Mn element satisfies a following relation: 0≤Co/Mn≤0.43.

According to the configuration described above, compositions in the positive electrode active material, in particular, a containing rate of Ni and a containing rate of a Co element with respect to a containing rate of a Mn element, are respectively configured to be within predetermined ranges. Furthermore, as the negative electrode active material, a Si containing material in addition to the carbon material is contained. By doing this, it is possible to provide the lithium ion secondary battery in which a cobalt content amount in the positive electrode active material is decreased and furthermore in which the resistance increase at the storing time is inhibited.

### BRIEF DESCRIPTION OF THE DRAWINGS

FIG. 1 is a cross section view that schematically shows an inside structure of a lithium ion secondary battery in accordance with one embodiment.

FIG. 2 is a schematic exploded view that shows a configuration of an electrode body of the lithium ion secondary battery in accordance with one embodiment.

FIG. 3 is a schematic view that shows a configuration of the negative electrode sheet (a negative electrode) in accordance with one embodiment.

FIG. 4 is a FIG. 3 correspondence diagram that shows a configuration of a negative electrode sheet (a negative electrode) in accordance with a second embodiment.

### DETAILED DESCRIPTION

Below, while suitably referring to figures, some preferred embodiments of the herein disclosed lithium ion secondary battery will be explained. The matters being other than matters particularly mentioned in this description and being required for implementing the present disclosure (for example, a general configuration and manufacturing process of the lithium ion secondary battery, by which the present disclosure is not characterized) can be grasped as design matters of those skilled in the art based on the related art in the present field. The lithium ion secondary battery disclosed herein can be executed based on the contents disclosed in the present description, and the technical common sense in the present field.

Incidentally, in the following accompanying figures, the members/parts providing the same effect are provided with the same numerals and signs, and overlapped explanation might be omitted or simplified. In addition, a wording “A to B” representing a range in the present description is to semantically cover a meaning of being equal to or more than A and not more than B, and further cover meanings of being “preferably more than A” and “preferably less than B”. Additionally, in the present description, a term “lithium ion secondary battery” (below, which might be referred to as simply “battery”) means a whole range of electric storage devices in which lithium ion is used as a charge carrier and in which repeatedly charging and discharging can be implemented by movement of the electric charge according to the lithium ion between positive and negative electrodes.

Below, the present disclosure would be described in detail while the lithium ion secondary battery, including an electrode body formed in a flat shape and a battery case formed in a flat shape and being formed in a flat square shape, is treated as an example, but it is not intended that the present disclosure is restricted to contents described in the embodiment.

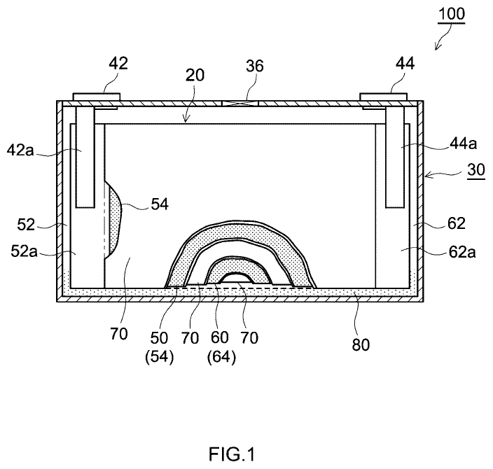

FIG. 1 is a cross section view that schematically shows an inside structure of the lithium ion secondary battery in accordance with one embodiment. The lithium ion secondary battery 100 shown in FIG. 1 is a sealed battery constructed by accommodating an electrode body 20 formed in a flat shape and a nonaqueous electrolyte 80 into a battery case (in other words, an exterior container) 30 formed in a flat square shape. The battery case 30 is provided with a positive electrode terminal 42 and a negative electrode terminal 44 which are used for outside connection, and is provided with a thin-walled safe valve 36 which is set to release an internal pressure when the internal pressure of the battery case 30 rises to a predetermined level or more. In addition, the battery case 30 is provided with an injection port (not shown in figures) for injecting a nonaqueous electrolyte 80. The positive electrode terminal 42 is electrically connected to a positive electrode current collection plate 42a. The negative electrode terminal 44 is electrically connected to a negative electrode current collection plate 44a. As a material of the battery case 30, for example, a metal material having a lightweight and having a good thermal conductivity, such as aluminum, can be used.

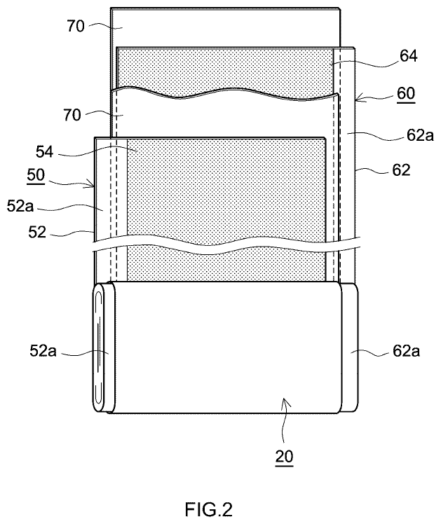

FIG. 2 is a schematic exploded view that shows a configuration of the electrode body of the lithium ion secondary battery in accordance with one embodiment. The electrode body 20 has a form, as shown in FIG. 1 and FIG. 2, in which a positive electrode sheet 50 formed in a strip-like shape and a negative electrode sheet 60 formed in a strip-like shape are stacked one on another through two separators 70 respectively formed in strip-like shapes and then are wound therein in a longitudinal direction. The positive electrode sheet 50 has a configuration in which a positive electrode active material layer 54 is formed on one surface or both surfaces (here, both surfaces) of a long positive electrode current collector 52 along a longitudinal direction. The negative electrode sheet 60 has a configuration in which a negative electrode active material layer 64 is formed on one surface or both surfaces (here, both surfaces) of a long negative electrode current collector 62 along the longitudinal direction. A positive electrode active material layer non-formation part 52a (in other words, a portion on which the positive electrode active material layer 54 is not formed and thus the positive electrode current collector 52 is exposed) and a negative electrode active material layer non-formation part 62a (in other words, a portion on which the negative electrode active material layer 64 is not formed and thus the negative electrode current collector 62 is exposed) are formed to protrude outwardly from both ends in a winding axis direction of the electrode body 20 (in other words, a sheet width direction orthogonal to the longitudinal direction described above). The positive electrode active material layer non-formation part 52a and the negative electrode active material layer non-formation part 62a are respectively joined to the positive electrode current collection plate 42a and the negative electrode current collection plate 44a. Incidentally, the positive electrode sheet 50 is an example of the herein disclosed “positive electrode”, and the negative electrode sheet 60 is an example of the herein disclosed “negative electrode”.

### ≤Positive Electrode>

The herein disclosed positive electrode (the positive electrode sheet 50) includes the positive electrode active material layer 54. As shown in FIG. 2, the positive electrode (the positive electrode sheet 50) herein includes the positive electrode current collector 52 and the positive electrode active material layer 54 supported by the positive electrode current collector 52. Incidentally, in the present practical example, the positive electrode active material layer 54 is shown, in figures, only on a surface at one side of the positive electrode current collector 52, but the positive electrode active material layer 54 might be provided on each of surfaces at both sides of the positive electrode current collector 52.

The positive electrode active material layer 54 contains the positive electrode active material that can reversibly store and release a charge carrier. The positive electrode active material in accordance with the present embodiment, as essential components, has a layered structure and contains a high Ni containing lithium-transition metal complex oxide that contains, as essential elements, lithium (Li), nickel (Ni), and manganese (Mn). Incidentally, the high Ni containing lithium-transition metal complex oxide is an example of the herein disclosed “lithium-transition metal complex oxide in which a Ni containing rate, with respect to a total of metal elements other than Li, is equal to or more than 75 mol %”.

The positive electrode active material might contain a positive electrode active material other than the high Ni containing lithium-transition metal complex oxide within a range where effects of the present disclosure are not inhibited (for example, less than 10 mass %, or preferably equal to or less than 5 mass %, with respect to a total mass of the positive electrode active materials). In addition, the positive electrode active material might be configured with only the high Ni containing lithium-transition metal complex oxide.

The high Ni containing lithium-transition metal complex oxide in accordance with the present embodiment has the Ni containing rate, with respect to metal elements other than Li, being equal to or more than 75 mol %. From a perspective of a high volume energy density of the lithium ion secondary battery, the Ni containing rate with respect to the total of metal elements other than Li is preferably equal to or more than 80 mol %, or further preferably equal to or more than 90 mol %. On the other hand, from a perspective of a high stability, the Ni containing rate with respect to the total of metal elements other than Li is preferably equal to or less than 95 mol %, or further preferably equal to or less than 93 mol %.

As the high Ni containing lithium-transition metal complex oxide having the layered structure, for example, it is possible to use a lithium nickel manganese type composite oxide, a lithium nickel cobalt manganese type composite oxide, a lithium nickel cobalt aluminum type composite oxide, a lithium iron nickel manganese type composite oxide, or the like. Regarding them, one kind might be used singly, or 2 or more kinds might be combined and then used. Whether a particle of the high Ni containing lithium-transition metal complex oxide has the layered structure (in other words, a layered crystal structure) can be confirmed by a well-known method (for example, an X-ray diffraction method, or the like).

Incidentally, “lithium nickel cobalt manganese type composite oxide” in the present description is a term that semantically covers not only oxides in which Li, Ni, Co, Mn, and O are configuration elements, but also covers an oxide containing 1 kind of or 2 or more kinds of additive elements other than them. As an example of the additive element described above, it is possible to use a transition metal element, a typical metal element, or the like, such as Mg, Ca, Al, Ti, V, Cr, Y, Zr, Nb, Mo, Hf, Ta, W, Na, Fe, Zn, and Sn. In addition, the additive element might be a semimetal element, such as B, C, Si, and P, or might be a non-metallic element, such as S, F, Cl, Br, and I. This thing is similar to the above described lithium nickel type composite oxide, lithium cobalt type composite oxide, lithium nickel manganese type composite oxide, lithium nickel cobalt aluminum type composite oxide, lithium iron nickel manganese type composite oxide, or the like.

In some suitable aspects, it is preferable that the high Ni lithium-transition metal complex oxide has a composition represented by general Chemical formula (i) described below.

Li_{α}NiₓMn_{y}M_{z}O₂ Chemical formula (i)

In the Chemical formula (i), x, y, z, and a respectively satisfy 0.8≤α≤1.2, 0.75≤x≤0.95, 0.05≤y≤0.25, and 0≤z≤0.2, and satisfy x+y+z=1. In Chemical formula (i), M represents at least one kind of element, selected from a group consisting of Mg, Ca, Co, Al, Ti, V, Cr, Zr, Nb, Mo, Hf, Ta, and W.

In Chemical formula (i), a preferably satisfies 0.9≤α≤1.2, or further preferably satisfies 1.0≤α≤1.1. From a perspective of a battery characteristic (for example, an energy density, a cycle characteristic, and a heat stability), x preferably satisfies 0.8≤x≤0.95, or further preferably satisfies 0.8≤x≤0.9. For example, from a perspective of the energy density, the heat stability, and a cost, y preferably satisfies 0.1≤y≤0.25, or further preferably satisfies 0.17≤y≤0.25. Then, z preferably satisfies 0≤z≤0.1, further preferably satisfies 0≤z≤0.03, or furthermore preferably is 0. Incidentally, in Chemical formula (i), the wording “x+y+z=1” not only means that x+y+z is 1, but also semantically covers that x+y+z is substantially recognized as 1 if the effect of the herein disclosed technique can be implemented, and thus it might be typically x+y+z=0.95 to 1.1 or might be preferably x+y+z=0.99 to 1.05.

Additionally, in a case where z in Chemical formula (i) satisfies 0≤z, it is further preferable from a point of making the initial resistance become smaller and from a perspective of making the layered crystal structure of the lithium-transition metal complex oxide become stable that M contains W.

Regarding the positive electrode active material, it is that a content amount (mol) of Co elements and a content amount (mol) of Mn elements satisfy a relation described below: 0≤Co/Mn≤0.43

By doing this, a containing ratio of the Co element and the Mn element in the positive electrode active material is controlled. Incidentally, under the relation described above, as the value of Co/Mn becomes smaller, it is possible to suitably decrease the cobalt content amount in the positive electrode active material and further to inhibit the resistance increase at the storing time, and thus 0≤Co/Mn≤0.32 is preferable, or 0≤Co/Mn≤0.21 is further preferable.

Regarding the positive electrode active material that is used for the conventional lithium ion battery, the containing ratio of Co element with respect to metal elements other than Li is typically about 10 mol % to 40 mol %. However, as the Co resource is limited, it is preferable that the containing rate of the Co in the positive electrode active material is decreased in comparison to a conventional one. Accordingly, in some suitable aspects, the Co containing ratio with respect to the total of metal elements other than Li is, for example, preferably equal to or less than 5 mol %, further preferably equal to or less than 3 mol %, or furthermore preferably 0 mol % (in other words, Co free).

An average particle diameter (D50) of the lithium-transition metal complex oxide is not particularly restricted. From a perspective of enhancing the energy density of the positive electrode active material layer and the output characteristic, the average particle diameter (D50) of the lithium-transition metal complex oxide is preferably 5 μm to 30 μm, or further preferably m to 20 μm. Incidentally, in the present description, the term “average particle diameter (D50)” represents a median diameter (D50) and additionally means a particle diameter corresponding to a cumulative frequency 50 volume % from one whose particle diameter is smaller (a microparticle side), on a volume basis particle size distribution based on a laser-diffraction_scattering method. Thus, it is possible to obtain the average particle diameter (D50) by using a laser-diffraction_scattering type particle size distribution measuring apparatus, or the like.

Although not particularly restricted, it is preferable that the lithium-transition metal complex oxide is formed in an approximately spherical shape. However, it might be formed in an indeterminate shape, or the like. Incidentally, the term “approximately spherical shape” in the present description represents a form capable of being recognized to be an approximately spherical body as a whole, and represents that the average aspect ratio (a long-diameter/short-diameter ratio) based on the cross section observation image of the electron microscope is, for example, 1 to 1.5. The lithium-transition metal complex oxide is, typically, in a secondary particle form where plural primary particles are aggregated by a physical or chemical bonding force. In other words, the lithium-transition metal complex oxide (in short, the secondary particle) is an aggregate of the primary particles, in which multiple primary particles are aggregated so as to form one particle.

A BET specific surface area of the lithium-transition metal complex oxide is not particularly restricted. In order to implement imparting the outstanding output characteristic to the lithium ion secondary battery, the BET specific surface area of the lithium-transition metal complex oxide is preferably 0.50 m²/g to 0.85 m²/g, or further preferably 0.55 m²/g to 0.80 m²/g. Incidentally, the BET specific surface area of the lithium-transition metal complex oxide can be measured by using a commercially available specific surface area measuring apparatus with a nitrogen adsorbent method.

The content amount of the positive electrode active material in the positive electrode active material layer 54 (in other words, the content amount of the positive electrode active material with respect to the total mass of the positive electrode active material layer 54), which is not particularly restricted, would be, for example, equal to or more than 80 mass %, preferably equal to or more than 87 mass %, further preferably equal to or more than 90 mass %, furthermore preferably equal to or more than 95 mass %, or the most preferably equal to or more than 97 mass %.

As the positive electrode current collector 52, it is possible to use a well known positive electrode current collector used for the lithium ion secondary battery, and as an example of it, it is possible to use a sheet or a foil made from a metal having a favorable electrically conductive property (for example, aluminum, nickel, titanium, stainless steel, or the like). As the positive electrode current collector 52, an aluminum foil is preferable.

A size of the positive electrode current collector 52, which is not particularly restricted, could be suitably decided in accordance with a battery design. In a case where the aluminum foil is used as the positive electrode current collector 52, a thickness of the positive electrode current collector 52, which is not particularly restricted, would be, for example, equal to or more than 5 μm and not more than 35 μm, or preferably equal to or more than 7 μm and not more than 20 μm.

### ≤Negative Electrode>

The herein disclosed negative electrode (the negative electrode sheet 60) includes the negative electrode active material layer 64. As shown in FIG. 2, the negative electrode (the negative electrode sheet 60) includes the negative electrode current collector 62, and the negative electrode active material layer 64 supported on the negative electrode current collector 62. Incidentally, in the present practical example, the negative electrode active material layer 64 is shown, in figures, only on a surface at one side of the negative electrode current collector 62, but the negative electrode active material layer 64 might be provided on each of surfaces at both sides of the negative electrode current collector 62.

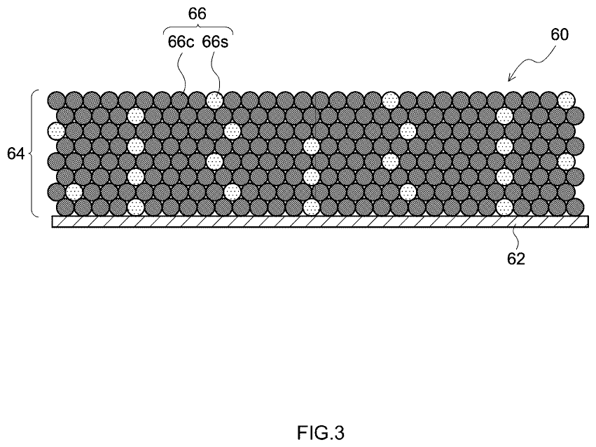

The negative electrode active material layer 64 contains the negative electrode active material 66 that can reversibly store and release the charge carrier. FIG. 3 is a schematic view that shows a configuration of the negative electrode sheet 60 (the negative electrode) in accordance with one embodiment. The negative electrode active material 66 in accordance with the present embodiment contains a carbon material 66c and a Si containing material 66s, as essential components. However, the negative electrode active material 66 might further contain the other negative electrode active material, in addition to the carbon material 66c and the Si containing material 66s. In addition, for convenience sake of explanation, although not shown in figures, the negative electrode active material layer 64 might contain an electrically conducting material, a binder, a thickening agent, or the like, in addition to the negative electrode active material 66.

As the carbon material 66c, for example, it is possible to use a graphite, a hard carbon, a soft carbon, or the like, and the graphite can be used suitably among them. The graphite might be a natural graphite or an artificial graphite, or might be an amorphous carbon covering graphite having a form in which the graphite is covered by the amorphous carbon material.

The average particle diameter of the carbon material 66c, which is not particularly restricted, would be, for example, equal to or more than 0.1 μm and not more than 50 μm, preferably equal to or more than 1 μm and not more than 25 μm, or further preferably equal to or more than 5 μm and not more than 20 μm. Incidentally, the average particle diameter (D50) of the carbon material can be obtained, for example, by a laser diffraction scattering method.

The Si containing material 66s is, for example, silicon (Si), a silicon oxide represented by SiOₓ (0.05≤x≤1.95), a Si—C composite containing a Si particle in a carbon particle, a lithium silicate (LiₓSi_{y}O_{z}), or the like. As the Si containing material 66s, it is possible to suitably use, the silicon, the silicon oxide, and the Si—C composite. In addition, as the Si containing material 66s, it is possible to use an alloy consisting of Si and an element other than the Si. As the element other than the Si, it is possible to use, for example, Fe, Co, Sb, Bi, Pb, Ni, Cu, Zn, Ge, In, Sn, Ti, or the like. By containing the Si containing material 66s in the negative electrode active material 66, it is possible to suppress formation of a covering film layer in which the Mn eluted from the positive electrode active material works as a start point on the negative electrode active material layer 64 surface. Therefore, it is possible to suitably suppress the resistance increase at the storing time.

The average particle diameter of the Si containing material 66s, which is not particularly restricted, would be, for example, equal to or more than 0.1 μm and not more than 50 μm, preferably equal to or more than 1 μm and not more than 25 μm, or further preferably equal to or more than 5 μm and not more than 20 μm. Incidentally, the average particle diameter (D50) of the carbon material can be obtained, for example, by the laser diffraction scattering method.

Although not particularly restricted, regarding the containing ratio of the Si element in the negative electrode active material 66 when the total amount of the negative electrode active material 66 is treated as 100 mass %, if the containing ratio of the Si element is equal to or more than 2 mass %, it is possible to obtain a formation suppressing effect of the covering film layer in which the Mn eluted from the positive electrode active material works as a reference point on the negative electrode active material layer 64 surface, and thus it is possible to express the suppressing effect of the storage resistance. As the containing ratio of the Si element is higher, it is possible to more suitably obtain the suppressing effect of the resistance increase at the storing time, but as the containing ratio of the Si element is lower, the capacity maintenance rate at the storing time tends to become more favorable. Accordingly, from a perspective of achieving both the effect of suppressing the resistance increase at the storing time and the capacity maintenance rate, the containing ratio of the Si element in the negative electrode active material 66 is preferably equal to or more than 2 mass % and not more than 13 mass %, or further preferably equal to or more than 5 mass % and not more than 10 mass %.

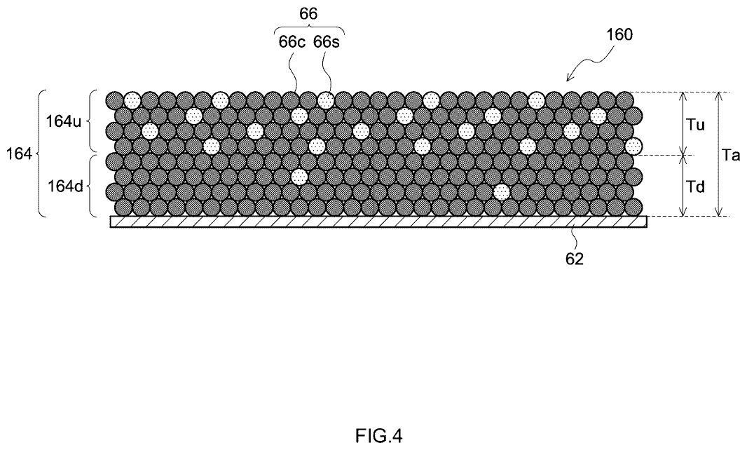

A distribution of the Si containing materials 66s in the negative electrode active material layer 64 is not particularly restricted, and the Si containing materials might be dispersed over the whole negative electrode active material layer 64, might be concentratedly dispersed on an upper layer of the negative electrode active material layer 64 (a surface layer side of the negative electrode active material layer 64) or might be concentratedly dispersed on a bottom layer of the negative electrode active material layer 64 (a negative electrode current collector 62 side). In some suitable aspects, it is preferable, as shown in a later described second embodiment (FIG. 4), that the Si containing material 66s is concentratedly dispersed on the upper layer of the negative electrode active material layer 64 (corresponding to a negative electrode upper layer 164u of FIG. 4). As shown in FIG. 3, in the present embodiment, the Si containing materials 66s are dispersed in an approximately uniform manner over the whole negative electrode active material layer 64. Incidentally, the wording “concentratedly dispersed on the upper layer of the negative electrode active material layer 64” is an example of a herein disclosed wording “when the Si element in the whole negative electrode active material is treated as 100 mass %, the containing ratio of the Si element on the negative electrode upper layer is equal to or more than 90 mass %”.

The negative electrode active material layer 64 might contain a component other than the negative electrode active material 66, such as electrically conducting material, binder, and thickening agent. As the binder, it is possible to use one used conventionally for the lithium secondary battery without particular restriction, for example, styrene butadiene rubber (SBR), polyvinylidene fluoride (PVDF), or the like. As the thickening agent, for example, it is possible to use carboxymethyl cellulose (CMC), or the like.

It is preferable that the negative electrode active material layer 64 further contains the electrically conducting material. As the electrically conducting material, it is possible to suitably use, for example, a carbon black (CB), such as acetylene black (AB) and Ketjen black, a carbon fiber, such as carbon nanotube (CNT) and vapor grown carbon fiber (VGCF), and a carbon material, such as activated carbon and graphite, and it is preferable among them to contain the CNT. By containing the CNT as the electrically conducting material, it is possible to suitably maintain the capacity maintenance rate. As the CNT, it is possible to use any of a single-walled carbon nanotube (SWCNT), a double-walled carbon nanotube (DWCNT), and a multi-walled carbon nanotube (MWCNT), and regarding them, it is possible to use a single one kind, or to combine 2 or more kinds so as to use the resultant. Regarding the negative electrode active material layer 64, in a case where the CNT is used as the electrically conducting material, it is preferable to use the SWCNT. In a case where the CNT is used as the electrically conducting material of the negative electrode active material layer 64, it is preferable to contain the CNT equal to or less than 0.5 mass % with respect to the whole negative electrode active material layer.

The content amount of the negative electrode active material 66 in the negative electrode active material layer 64 is preferably equal to or more than 90 mass %, or further preferably equal to or more than 95 mass % and not more than 99 mass %. The content amount of the binder in the negative electrode active material layer 64 is preferably equal to or more than 0.1 mass % and not more than 8 mass %, or further preferably equal to or more than 0.5 mass % and not more than 3 mass %. The content amount of the thickening agent in the negative electrode active material layer 64 is preferably equal to or more than 0.3 mass % and not more than 3 mass %, or further preferably equal to or more than 0.5 mass % and not more than 2 mass %.

A thickness of the negative electrode active material layer 64, which is not particularly restricted, would be, for example, equal to or more than 10 μm and not more than 200 μm, or preferably equal to or more than 20 μm and not more than 100 μm, in a case where the negative electrode active material layer 64 is provided only on the surface at one side of the negative electrode current collector 62. Additionally, in a case where the negative electrode active material layer 64 is provided on both surfaces of the negative electrode current collector 62, on one surface (regarding a thickness of each of one surface and the other one surface), it would be, for example, equal to or more than 10 μm and not more than 200 μm, or preferably equal to or more than 20 μm and not more than 100 μm.

As the negative electrode current collector 62, it is possible to use a well known negative electrode current collector used for the lithium ion secondary battery, and as an example of it, it is possible to use a sheet or a foil made from a metal having a favorable electrically conductive property (for example, copper, nickel, titanium, stainless steel, or the like). As the negative electrode current collector 62, a copper foil is preferable.

A size of the negative electrode current collector 62, which is not particularly restricted, could be suitably decided in accordance with the battery design. In a case where the copper foil is used as the negative electrode current collector 62, a thickness of the negative electrode current collector 62, which is not particularly restricted, would be, for example, equal to or more than 5 μm and not more than 35 μm, or preferably equal to or more than 7 μm and not more than 20 μm.

As the separator 70, it is possible to use various porous sheets similar to those conventionally used for the lithium ion secondary battery, and it is possible, as the example, to use a porous resin sheet consisting of a resin, such as polyethylene (PE) and polypropylene (PP). The porous resin sheet described above might have a single layer structure, or might have a plural layers structure configured with two or more layers (for example, a three layers structure in which PP layers are laminated on both surfaces of a PE layer). The separator 70 might include a heat resistance layer (HRL).

As the nonaqueous electrolyte 80, it is possible to use one similar to the conventional lithium ion secondary battery, and typically it is possible to use one in which a supporting salt is contained into an organic solvent (a nonaqueous solvent). As the nonaqueous solvent, it is possible to use an aprotic solvent, such as carbonates, esters, and ethers. Among them, the carbonates are preferable, since the decrease effect on a low temperature resistance due to the positive electrode material becomes particularly high. As an example of the carbonates, it is possible to use ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluoro dimethyl carbonate (TFDMC), or the like. For the nonaqueous solvent as described above, it is possible to use one consisted of single kind or consisted by suitably combining 2 or more kinds. As the supporting salt, for example, it is possible to suitably use a lithium salt, such as LiPF₆, LiBF₄, and lithium bis(fluorosulfonyl)imide (LiFSI). A concentration of the supporting salt is preferably equal to or more than 0.7 mol/L and not more than 1.3 mol/L.

Incidentally, the nonaqueous electrolyte 80 could contain a component, other than the above described nonaqueous solvent and supporting salt, which might be various additive agents, such as gas generating agent, covering film forming agent, dispersing agent, and thickening agent, if the effect of the present disclosure is not significantly spoiled. As the additive agent used for the nonaqueous electrolyte 80, for example, it is possible to use a positive and negative electrode covering film forming agent, such as vinylene carbonate (VC), fluoro ethylene carbonate (FEC), and 1,3-propane sultone (PS); an overcharge preventing agent, such as biphenyl (BP), cyclohexylbenzene (CHB), t-butylbenzene, and t-amylbenzene; or the like. Among them, it is preferable to contain the FEC as the additive agent used for the nonaqueous electrolyte 80. In a case of containing the FEC as the additive agent in the nonaqueous electrolyte 80, it is preferable that the FEC is contained at a rate equal to or less than 20 vol % with respect to the nonaqueous electrolyte 80.

The lithium ion secondary battery 100 configured as described above uses the high Ni containing lithium-transition metal complex oxide as the positive electrode active material, and the containing rate (mol) of the Co element and the containing rate (mol) of the Mn element in the positive electrode active material satisfy a following relation: 0≤Co/Mn≤0.43. In addition, the negative electrode active material contains the carbon material and the Si containing material. By doing this, it is possible to decrease the cobalt content amount in the positive electrode active material and further to inhibit the resistance increase at the storing time.

While described in detail, in a case where the lithium-transition metal complex oxide having the layered structure containing the Mn is used as the positive electrode active material, if the Co containing rate in the positive electrode active material is reduced, the stability of the positive electrode active material is reduced and the Mn elution from the positive electrode active material layer becomes remarkable at the storing time. The eluted Mn is precipitated on the surface of the negative electrode active material layer (typically, a graphite surface), and furthermore a covering film growth occurs with the precipitated Mn being as the start point. By the covering film described above, a durability degradation of the lithium ion secondary battery occurs. Thus, conventionally, regarding the lithium ion secondary battery that uses the lithium-transition metal complex oxide as the positive electrode active material, the lithium-transition metal complex oxide having the layered structure containing the Mn and having the Co containing rate being decreased, there is a problem that the resistance increase at the storing time becomes larger.

In contrast to this matter, regarding the lithium ion secondary battery 100 in accordance with the present embodiment, the high Ni containing lithium-transition metal complex oxide is contained as the positive electrode active material. In other words, regarding the above described lithium-transition metal complex oxide, the Ni containing rate with respect to the total of metal elements other than the Li is equal to or more than 75 mol % and thus, it is possible to suppress the Mn rate in the lithium-transition metal complex oxide. In addition, by making the containing rate (mol) of the Co element and the containing rate (mol) of the Mn element in the positive electrode active material satisfy 0≤Co/Mn≤0.43, a containing ratio of the Co element and the Mn element in the positive electrode active material is controlled. Furthermore, by the Si containing material contained in the negative electrode active material, the precipitation of the Mn onto the negative electrode surface is suppressed. By doing this, it is possible to inhibit the Mn covering film formation on the negative electrode surface. Accordingly, it is possible to provide the lithium ion secondary battery 100 in which the resistance increase at the storing time is suppressed.

The lithium ion secondary battery 100 can be used for various purposes. As a suitable purpose, it could be applied to a power supply for driving mounted on a vehicle, such as Battery Electric Vehicle (BEV), Hybrid Electric Vehicle (HEV), and Plug-in Hybrid Electric Vehicle (PHEV). In addition, the lithium ion secondary battery 100 can be used as a storage battery, such as small electric power storing apparatus. The lithium ion secondary battery 100 can be used in a form of a battery pack typically configured by connecting plural batteries in series and/or in parallel.

Incidentally, as an example, the square shaped lithium ion secondary battery 100 including the electrode body 20 having the flat shaped wound structure has been explained. However, the lithium ion secondary battery disclosed herein can be configured as a lithium ion secondary battery including a laminate type electrode body (in other words, an electrode body in which plural positive electrodes and plural negative electrodes are alternately laminated). The laminate type electrode body might include plural separators so as to dispose one separator at each position between the positive electrode and the negative electrode, or might be configured by turning one separator so as to alternately laminate the positive electrode and the negative electrode. In addition, the lithium ion secondary battery in accordance with the present embodiment can be constructed in a form, such as cylindrical type lithium ion secondary battery, coin type lithium ion secondary battery, and laminate type lithium ion secondary battery. Furthermore, it is possible to construct an all-solid state secondary battery in which the electrolyte is made to be a solid electrolyte.

### Second Embodiment

FIG. 4 is a FIG. 3 corresponding diagram of a negative electrode sheet 160 (the negative electrode) in accordance with a second embodiment. In FIG. 4, matters other than including the negative electrode active material layer 164 instead of the negative electrode active material layer 64 might be similar to the above described lithium ion secondary battery 100. As shown in FIG. 4, the negative electrode active material layer 164 has a so-called plural layers structure, including a negative electrode upper layer 164u and a negative electrode lower layer 164d.

In some suitable aspects, the negative electrode active material layer 164 in view of a thickness direction can include a negative electrode lower layer 164d connected to the negative electrode current collector 62 and a negative electrode upper layer 164u apart from the negative electrode current collector 62 more than the negative electrode lower layer 164d. However, the negative electrode active material layer 164 might have the plural layers structure configured with 3 or more layers. For example, between the negative electrode upper layer 164u and the negative electrode lower layer 164d, a layer having a composition different from the negative electrode upper layer 164u and from the negative electrode lower layer 164d might be further formed.

The negative electrode upper layer 164u is a layer positioned at a surface side more than the negative electrode lower layer 164d, when it is viewed in the thickness direction of the negative electrode active material layer 164. The negative electrode upper layer 164u is positioned apart from the negative electrode current collector 62 more than the negative electrode lower layer 164d. The negative electrode upper layer 164u herein configures the most surface layer of the negative electrode active material layer 164. In other words, the negative electrode upper layer 164u is positioned at the positive electrode (the positive electrode sheet 50) side more than the negative electrode lower layer 164d.

The negative electrode active material 66 in accordance with the negative electrode upper layer 164u includes the Si containing material 66s, as the essential component. When the Si element amount of the whole negative electrode active material layer 164 is treated as 100 mass %, the containing ratio of the Si element contained in the negative electrode upper layer 164u is preferably equal to or more than 90 mass %, further preferably equal to or more than 95 mass %, or furthermore preferably equal to or more than 98 mass %. Typically, the content amount of the Si element contained in the negative electrode upper layer 164u is larger than the content amount of the Si element contained in the negative electrode lower layer 164d.

In other words, regarding the negative electrode active material layer 164, the Si elements are concentratedly dispersed at the positive electrode (the positive electrode sheet 50) side.

As described above, the Mn eluted from the positive electrode active material layer 54 is precipitated from the positive electrode (the positive electrode sheet 50) side on the negative electrode active material layer 64, in other words, from the surface layer of the negative electrode active material layer 164, so as to form the covering film. Here, by including the configuration in which the Si containing materials are concentratedly dispersed at the positive electrode (the positive electrode sheet 50) side, in other words, the negative electrode upper layer 164u side, on the negative electrode active material layer 164, it is possible to further efficiently implement an effect of suppressing the covering film formation on the negative electrode active material layer 164 surface due to the Mn. Accordingly, it is possible to suitably suppress the resistance increase at the storing time.

Incidentally, “containing ratio (mass %) of the Si element contained in the negative electrode upper layer when the Si element amount in the whole negative electrode active material layer is treated as 100%” in the present description can be calculated as described below. At first, by observing a cross section SEM image of the negative electrode active material layer 164, a thickness of the negative electrode upper layer is obtained. Then, with respect to a predetermined area of the negative electrode active material layer, the negative electrode active material layer corresponding to the thickness of the obtained negative electrode upper layer is scraped to collect a sample, and then to perform an ICP (Inductively Coupled Plasma) analysis, so as to calculate the Si element amount in the negative electrode upper layer. Regarding the negative electrode lower layer, similarly, the negative electrode active material layer corresponding to a predetermined area is scraped to collect the sample, and then to perform the ICP analysis, so as to calculate the Si element amount in the negative electrode lower layer. Then, based on values of the respectively obtained Si element amounts of the negative electrode upper layer and the negative electrode lower layer, it is possible to obtain the containing ratio of the Si element in the negative electrode upper layer with respect to the Si element amount of the whole negative electrode active material layer.

The content amount of the Si element contained in the negative electrode upper layer 164u is preferably equal to or more than 2 mass %, or further preferably equal to or more than 5 mass %, when a total of the negative electrode active material 66 of the negative electrode upper layer 164u is treated as 100 mass %.

The negative electrode lower layer 164d is a layer positioned at the negative electrode current collector 62 side more than the negative electrode upper layer 164u, when it is viewed in the thickness direction of the negative electrode active material layer 64. Here, the negative electrode lower layer 164d comes into contact with the negative electrode current collector 62.

The negative electrode active material 66 in accordance with the negative electrode lower layer 164d contains the carbon material 66c as the essential components. The negative electrode lower layer 164d might contain the Si containing material 66s, or might not contain the Si containing material 66s. The content amount of the Si element contained in the negative electrode lower layer 164d, which is not particularly restricted, might be, for example, equal to or less than 2 mass %, or preferably equal to or less than 1 mass %, when the negative electrode active material of the negative electrode lower layer 164d is treated as 100 mass %. The content amount of the C element contained in the negative electrode lower layer 164d, which is not particularly restricted, is preferably equal to or more than 98 mass %, or further preferably equal to or more than 99 mass %, when the negative electrode active material of the negative electrode lower layer 164d is treated as 100 mass %.

A ratio (Tu/Ta) of a thickness Tu of the negative electrode upper layer 164u with respect to a whole thickness Ta of the negative electrode active material layer 164 is, for example, equal to or less than 0.8, or might be preferably equal to or less than 0.7. By doing this, it is possible to disperse the Si containing materials 66s in the negative electrode active material layer 164 (in other words, the Si elements) to the positive electrode (the positive electrode sheet 50) side, and thus the effect of suppressing the covering film formation by the Mn is further efficiently expressed. Accordingly, it is possible to suitably suppress the resistance increase at the storing time. In addition, from a perspective of a filling ability, the ratio of the thickness Tu of the negative electrode upper layer 164u with respect to the whole thickness Ta of the negative electrode active material layer 164 is, for example, equal to or more than 0.4, or might be preferably equal to or more than 0.5. Incidentally, “ratio of the thickness of the negative electrode upper layer with respect to the whole thickness of the negative electrode active material layer” in the description is measured on the basis of the cross section SEM image of the negative electrode active material layer 164.

Incidentally, the negative electrode upper layer 164u and the negative electrode lower layer 164d as described above can be manufactured by a conventionally known method. Although not restricted, for example, it can be formed by using 2 or more kinds of negative electrode active materials 66 having different compositions (typically, containing ratios of the Si containing materials) from each other so as to prepare a slurry for forming the negative electrode active material layer and then by coating with the slurry for forming the negative electrode active material layer.

Below, a practical example related to the herein disclosed technique will be explained, which is not intended to restrict the herein disclosed technique to the practical example.

### ≤Test Example 1: Examination of Si Presence or Absence in Negative Electrode Active Material>

### Example 1

### [Manufacture of Positive Electrode Sheet]

The lithium-transition metal complex oxide which had the layered structure and whose composition (mol ratio) of the Ni, the Co, and the Mn was Ni:Co:Mn=83:0:17 (corresponding to 83/0/17 on “Ni/Co/Mn” column in Table 1) was prepared so as to treat it as the positive electrode active material in accordance with Example 1. Incidentally, the Li mol rate (Li/(Ni+Co+Mn)) with respect to a total of the transition metal elements (Ni+Co+Mn) of the lithium-transition metal complex oxide was set to be 1.0 mol %. The above prepared positive electrode active material, acetylene black (AB) as the electrically conducting material, and polyvinylidene fluoride (PVDF) as the binder were mixed at a solid content mass ratio being positive electrode active material:AB:PVDF=100:1:1. To the obtained mixture, a proper amount of N-methyl-2-pyrrolidone (NMP) was added and kneaded, so as to prepare the slurry for forming the positive electrode active material layer. With the obtained slurry for forming the positive electrode active material layer, both surfaces of the positive electrode current collector made from an aluminum foil whose thickness was 15 μm was coated, the resultant was dried, and thus the positive electrode active material layer was formed. The obtained positive electrode active material layer was subjected to a roll press with a rolling roller, and then cut to have a predetermined size, and thus the positive electrode sheet was manufactured.

### [Manufacture of Negative Electrode Sheet]

At first, a graphite as the carbon material and a Si—C composite as the Si containing material were mixed to make the containing ratio of the Si element be 10 mass % and make the containing ratio of the C element be 90 mass % when the total amount of the negative electrode active material was treated as 100 mass %, and thus the negative electrode active material was manufactured. The above prepared negative electrode active material, styrene butadiene rubber (SBR) as the binder, carboxymethyl cellulose (CMC) as the thickening agent, and single-walled carbon nanotube (SWCNT) as the electrically conducting material were mixed in an ion exchange water to satisfy a solid content mass ratio being negative electrode active material:SBR:CMC:SWCNT=100:1:1:0.5, and thus the slurry for forming the negative electrode active material layer was prepared. With the obtained slurry for forming the negative electrode active material layer, the negative electrode current collector made from a copper foil whose thickness was 10 μm was coated, the resultant was dried, and thus the negative electrode active material layer was formed. The obtained negative electrode active material layer was subjected to the roll press with the rolling roller, and then cut to be a predetermined size. By doing this, the negative electrode sheet in accordance with Example 1 was manufactured in which the Si containing materials were dispersed in an approximately uniform manner over the whole negative electrode active material.

### [Preparation of Separator]

As the separator, a porous polyolefin sheet was prepared which had three layers structure of PP/PE/PE, and whose thickness was 20 μm.

### [Preparation of Nonaqueous Electrolyte]

As the nonaqueous electrolyte, what LiPF₆ as the supporting salt was dissolved at a concentration of 1 mol/L into a mix solvent containing ethylene carbonate (EC), ethyl methyl carbonate (EMC), dimethyl carbonate (DMC), and fluoro ethylene carbonate (FEC) at the volume ratio being EC:EMC:DMC:FEC=25:40:30:5 was prepared.

### [Manufacture of Lithium Ion Secondary Battery for Evaluation]

The positive electrode sheet and the negative electrode sheet were superimposed with the separator being disposed between them, so as to obtain a laminate body. Then, the laminate body was wound to obtain a wound body, then the wound body was subjected to a pressing process to be a flat shape, and thus the electrode body formed in a flat shape was obtained. To the electrode body, an electrical collector terminal was attached, the resultant was inserted into a battery case and welded, and then the nonaqueous electrolyte was injected.

After that, by sealing the battery case, the lithium ion secondary battery for evaluation was manufactured.

### [Initial Charging Process]

On the obtained lithium ion secondary battery for evaluation in accordance with Example 1, a constant current charge was performed under a 25° C. temperature environment with a current value of 0.1 C as an initial charging process, till a voltage of 4.2 V, and then the constant voltage charge was performed until the current value reaches 1/20 C. After that, the constant current electric discharge was performed with the 0.1 C current value till 3.0 V.

### Examples 2 to 4

Except for changing the composition (mol ratio) of the Ni, Co, and Mn in the positive electrode active material to be as shown at “Ni/Co/Mn” column in Table 1, similarly to Example 1, the lithium ion secondary batteries for evaluation in accordance with Examples 2 to 4 were manufactured and then the initial charging process was performed.

### Examples 5 to 8

Except for changing the composition (mol ratio) of the Ni, Co, and Mn in the positive electrode active material to be as shown at “Ni/Co/Mn” column in Table 1, and except for making the negative electrode active material be only the graphite (in other words, not containing the Si containing material), similarly to Example 1, the lithium ion secondary batteries for evaluation in accordance with Examples 5 to 8 were manufactured and then the initial charging process was performed.

### Reference Example

In addition, as a reference example, except for making the composition (mol ratio) of the Ni, Co, and Mn in the positive electrode active material be 83:5:12 and making the negative electrode active material be only the graphite (in other words, not containing the Si containing material), the lithium ion secondary battery for evaluation similar to Example 1 was manufactured and then the initial charging process was performed.

### [Evaluation of Storage Resistance Increasing Rate]

Regarding the lithium ion secondary batteries for evaluation in accordance with Examples 1 to 8 and with the reference example, at first, in 25° C. thermostatic chamber, on each lithium ion secondary battery for evaluation, a constant current constant voltage (CCCV) charge was performed at 0.3 C current value, so as to adjust a SOC (State of Charge) being in 50% state. After that, a pulse electric discharge was performed at 5 C current value for 10 seconds. A voltage change amount (AV) at this pulse electric discharge was obtained, and then the resistance value before storage (the initial resistance) was calculated with the below described Formula (I):

$$Resistance value = Voltage change amount ( Δ V ) / Current value ( 5 C ) \qquad ( I )$$

Then, an adjustment was performed to have SOC 100% under 25° C. temperature environment. Each of these lithium ion secondary batteries for evaluation was kept in 60° C. thermostatic chamber, and then stored for 14 days. Then, by a method the same as the initial resistance, the resistance value after the storage was calculated. Then, a resistance increasing rate (%) was obtained by the below described Formula (II):

$$Resistance increasing rate ( \% ) = ( Resistance value after storage / Resistance value before storage ) \times 100 \qquad ( II )$$

Results are shown in Table 1.

### [Table 1]

TABLE 1

| | | | Negative electrode | | Storing time |
|---|---|---|---|---|---|
| | | | | Si containing | Resistance |
| | Positive electrode | | | ratio | increasing |
| | Ni/Co/Mn | Co/Mn ratio | Composition | (mass %) | rate (%) |
| Example 1 | 83/0/17 | 0 | Graphite + Si | 10 | 109 |
| Example 2 | 83/1/16 | 0.06 | Graphite + Si | 10 | 107 |
| Example 3 | 83/3/14 | 0.21 | Graphite + Si | 10 | 106 |
| Example 4 | 83/4/13 | 0.31 | Graphite + Si | 10 | 106 |
| Example 5 | 83/0/17 | 0 | Graphite | 0 | 121 |
| Example 6 | 83/1/16 | 0.06 | Graphite | 0 | 115 |
| Example 7 | 83/3/14 | 0.21 | Graphite | 0 | 110 |
| Example 8 | 83/4/13 | 0.31 | Graphite | 0 | 108 |
| Reference example | 83/5/12 | 0.42 | Graphite | 0 | 106 |

As shown in the results of Table 1, in comparison to the reference example and Examples 5 to 8, the resistance increasing rate at the storing time is increased more when the Co containing ratio in the positive electrode active material is decreased more, and thus it can be understood that the resistance characteristic is deteriorated. However, in Examples 1 to 4, by containing the Si—C composite in addition to the graphite as the negative electrode active material, the resistance increase at the storing time was suppressed in comparison to Examples 5 to 8, so as to show a resistance increasing rate closer to the reference example.

### ≤Test Example 2: Examination of Ni Mixing Ratio in Positive Electrode Active Material>

### Examples 9 to 16

Except for changing the composition (mol ratio) of the Ni, Co, and Mn in the positive electrode active material to be as shown at “Ni/Co/Mn” column in Table 2, similarly to Example 1, the lithium ion secondary batteries for evaluation in accordance with Examples 9 to 16 were manufactured and then the initial charging process was performed. On the lithium ion secondary batteries for evaluation in accordance with Examples 9 to 16, an evaluation of the resistance increasing rate at the storing time was performed similarly to the above described method. Results are shown in Table 2.

TABLE 2

| | | | Negative electrode | | Storing time |
|---|---|---|---|---|---|
| | | | | Si containing | Resistance |
| | Positive electrode | | | ratio | increasing |
| | Ni/Co/Mn | Co/Mn ratio | Composition | (mass %) | rate (%) |
| Example 9 | 90/0/10 | 0 | Graphite + Si | 10 | 108 |
| Example 10 | 90/1/9 | 0.11 | Graphite + Si | 10 | 108 |
| Example 11 | 90/2/8 | 0.25 | Graphite + Si | 10 | 106 |
| Example 12 | 90/3/7 | 0.43 | Graphite + Si | 10 | 106 |
| Example 13 | 75/0/25 | 0 | Graphite + Si | 10 | 110 |
| Example 14 | 75/2/23 | 0.09 | Graphite + Si | 10 | 110 |
| Example 15 | 75/4/21 | 0.19 | Graphite + Si | 10 | 109 |
| Example 16 | 75/6/19 | 0.32 | Graphite + Si | 10 | 107 |

As shown in the results of Table 2, on Examples 9 to 12 whose Ni mixing ratio in the positive electrode active material was 90 mol % and additionally on Examples 13 to 16 whose Ni mixing ratio in the positive electrode active material was 75 mol %, the resistance suppressing effect at the storing time was observed.

### ≤Test Example 3: Examination of Si Rate>

### Examples 17 to 19

Except for changing, regarding the graphite as the carbon material and the Si—C composite as the Si containing material, the containing ratio of the Si element to be as shown at “Si containing ratio” column in Table 3 when the total amount of the negative electrode active materials was treated as 100 mass %, similarly to Example 1, the lithium ion secondary batteries for evaluation in accordance with Examples 17 to Example 19 were manufactured and then the initial charging process was performed. On the lithium ion secondary batteries for evaluation in accordance with Example 17 to Example 19, an evaluation of the resistance increasing rate at the storing time was performed similarly to the above described method. Results are shown in Table 3.

### [Capacity Maintenance Rate]

Furthermore, on the present test example, in parallel to the evaluation of the resistance increasing rate at the storing time, an evaluation of the capacity maintenance rate was performed. At first, regarding the lithium ion secondary batteries for evaluation in accordance with Example 1, Example 5, and Example 17 to Example 19, an electric discharge capacity measured at a resistance increasing rate evaluating time was treated as an initial capacity. After that, an electric discharge capacity of the lithium ion secondary battery for evaluation on which the storage was performed for the resistance increasing rate evaluation at the storing time (in other words, after being stored at 60° C. for 14 days) was obtained by a method similar to the initial capacity. Then, capacity maintenance rates (%) in accordance with Example 1, Example 5, and Example 17 to Example 19 were obtained by the below described Formula (III):

$$Capacity maintenance rate ( \% ) = Electric discharge capacity after 14 days storage / Initial capacity \times 100 \qquad ( III )$$

Results are shown in Table 3.

TABLE 3

| | | | Negative electrode | | Storing time | |
|---|---|---|---|---|---|---|
| | Positive electrode | | | Si containing | Resistance | Capacity |
| | | Co/Mn | | ratio | increasing | retention |
| | Ni/Co/Mn | ratio | Composition | (mass %) | rate (%) | rate (%) |
| Example 1 | 83/0/17 | 0 | Graphite + Si | 10 | 109 | 95.4 |
| Example 17 | 83/0/17 | 0 | Graphite + Si | 5 | 112 | 95.5 |
| Example 18 | 83/0/17 | 0 | Graphite + Si | 2 | 119 | 95.4 |
| Example 19 | 83/0/17 | 0 | Graphite + Si | 13 | 107 | 94.5 |
| Example 5 | 83/0/17 | 0 | Graphite | 0 | 121 | 95.5 |

As shown in the results of Table 3, even on Example 18 whose containing ratio of the Si element was 2 mass %, in comparison to Example 5 in which only the graphite was used as the negative electrode active material, the effect of suppressing the resistance increase at the storing time was observed. In addition, it is thought that the effect of suppressing the increase in the battery resistance is more favorably expressed as the containing ratio of the Si element becomes higher, but that the capacity maintenance rate is more favorable as the containing ratio of the Si element is smaller. Accordingly, from a perspective of achieving both the resistance increase suppressing effect at the storing time and the capacity maintenance rate, it is thought regarding the containing ratio of the Si element in the negative electrode active material that 5 to 10 mass % is a further suitable range.

### ≤Test Example 4: Examination of Si Containing Material Distribution in Negative Electrode Active Material Layer>

### Examples 20 to 21

Except for making the negative electrode active material be only the graphite (in other words, the Si element containing ratio was 0 mass % and the C element containing ratio was 100 mass %, when the total amount of the negative electrode active material was treated as 100 mass %), similarly to Example 1, a first slurry for forming the negative electrode active material layer was prepared.

Similarly, except for respectively making the graphite and the Si—C composite have the Si element containing ratio being 20 mass % and the C element containing ratio being 80 mass % when the total amount of the negative electrode active material was treated as 100 mass %, similarly to Example 1, a second slurry for forming the negative electrode active material layer was prepared.

The negative electrode current collector made of the copper foil the same as one used in Example 1 was coated with the first slurry for forming the negative electrode active material layer, dried, and then subjected to the roll press by the rolling roller so as to have a predetermined density. Then, the dried covering film of the first slurry for forming the negative electrode active material layer was coated with the second slurry for forming the negative electrode active material layer, dried, and then subjected to the roll press by the rolling roller so as to have a predetermined density. At that time, the thickness of the second slurry for forming the negative electrode active material layer was adjusted to be 0.5 with respect to the thickness of the whole negative electrode active material layer. By doing this, the negative electrode sheet of Example 20 was obtained in which a negative electrode lower layer formed with the first slurry for forming the negative electrode active material layer and a negative electrode upper layer formed with the second slurry for forming the negative electrode active material layer were supported on the negative electrode current collector. Incidentally, regarding the negative electrode sheet of Example 20, the Si element containing ratio of the negative electrode upper layer was 99 mass % when the Si element of the whole negative electrode active material was treated as 100 mass %.

Similarly, the negative electrode current collector made of the copper foil the same as one used in Example 1 was coated with the second slurry for forming the negative electrode active material layer, dried, and then subjected to the roll press by the rolling roller so as to have a predetermined density. Then, the dried covering film of the second slurry for forming the negative electrode active material layer was coated with the first slurry for forming the negative electrode active material layer, dried, and then subjected to the roll press by the rolling roller so as to have a predetermined density. At that time, a thickness of the first slurry for forming the negative electrode active material layer was adjusted to be 0.5 with respect to the thickness of the whole negative electrode active material layer. By doing this, the negative electrode sheet of Example 21 was obtained in which the negative electrode lower layer formed with the second slurry for forming the negative electrode active material layer and the negative electrode upper layer formed with the first slurry for forming the negative electrode active material layer were supported on the negative electrode current collector. Incidentally, regarding the negative electrode sheet of Example 21, the Si element containing ratio of the negative electrode upper layer was 1 mass % when the Si element of the whole negative electrode active material was treated as 100 mass %.

Except for using the negative electrode sheet described above, similarly to Example 1, the batteries for evaluation in accordance with Example 20 and Example 21 were manufactured and then the initial charging process was performed. On the lithium ion secondary batteries for evaluation in accordance with Example 20 and Example 21, the evaluation of storage resistance increasing rate was performed, similarly to the above described method. Results are shown in Table 4.

TABLE 4

| | | | Negative electrode | | | Storing time |
|---|---|---|---|---|---|---|
| | Positive electrode | | | Si containing | | Resistance |
| | | Co/Mn | | ratio | | increasing |
| | Ni/Co/Mn | ratio | Composition | (mass %) | Si distribution | rate (%) |
| Example 1 | 83/0/17 | 0 | Graphite + Si | 10 | Whole | 109 |
| Example 20 | 83/0/17 | 0 | Graphite + Si | 10 | Concentrated on | 107 |
| | | | | | negative electrode | |
| | | | | | upper layer | |
| Example 21 | 83/0/17 | 0 | Graphite + Si | 10 | Concentrated on | 117 |
| | | | | | negative electrode | |
| | | | | | lower layer | |
| Example 5 | 83/0/17 | 0 | Graphite | 0 | — | 121 |

As shown in the results of Table 4, regarding any of Example 1, Example 20, and Example 21, the effect of suppressing the resistance increase at the storing time was observed, in comparison to Example 5 in which only the graphite was used as the negative electrode active material. In view of Example 1, Example 20, and Example 21, each of which had the Si mixing rates being 10 mass %, the result was obtained in Example 1 whose Si containing materials (Si—C composites) were uniformly dispersed over the whole negative electrode active material layer that the effect of suppressing the resistance increasing rate at the storing time was favorable, and the result was obtained in Example 20 whose Si containing materials (Si—C composites) were concentratedly arranged on the upper layer that suppressing the resistance increasing rate at the storing time was further favorable. The reasons for these things are thought that, by concentratedly arranging the Si containing materials on the upper layer of the negative electrode active material, the effect of suppressing the Mn precipitation due to the Si containing material was efficiently expressed on the negative electrode active material surface.

Above, a preferred embodiment of the present disclosure has been explained, but the above described embodiment is merely an example. The present disclosure can be implemented in various other forms. The present disclosure can be executed based on the contents disclosed in the present description, and the technical common sense in the present field. The technique recited in the appended claims includes variously deformed or changed versions of the embodiments that have been illustrated above. For example, it is possible to replace a part of the above described embodiment with a different modified example, and a different modified example could be added to the above described embodiment. In addition, unless a technical feature is explained to be essential, this technical feature can be appropriately deleted.

While described above, as a particular aspect of the herein disclosed technique, it is possible to use a recitation of each item described below.

Item 1: A lithium ion secondary battery, comprising: a positive electrode; a negative electrode; a separator; and a nonaqueous electrolyte, wherein the positive electrode comprises a positive electrode active material layer that contains a positive electrode active material, the positive electrode active material is a lithium-transition metal complex oxide that contains Li, Ni, and Mn and that has a layered structure, on the lithium-transition metal complex oxide, a containing rate of the Ni is equal to or more than 75 mol % with respect to a total of metal elements other than the Li, the negative electrode comprises a negative electrode active material layer that contains a negative electrode active material, the negative electrode active material contains a carbon material and a Si containing material, and in the positive electrode active material, a containing rate (mol) of a Co element and a containing rate (mol) of a Mn element satisfy a following relation: 0≤Co/Mn≤0.43.

Item 2: The lithium ion secondary battery recited in item 1, wherein in the positive electrode active material, a content amount (mol) of the Co element and a content amount (mol) of the Mn element satisfy a below described relation: 0≤Co/Mn≤0.32.

Item 3: The lithium ion secondary battery recited in item 1 or 2, wherein the positive electrode active material is represented by a following general chemical formula: Li_{α}NiₓMn_{y}M_{z}O₂ (incidentally, 0.8≤α≤1.2, 0.75≤x≤0.95, 0.05≤y≤0.25, 0≤z≤0.2, x+y+z=1, and M is equal to or more than 1 kind selected from Mg, Ca, Co, Al, Ti, V, Cr, Zr, Nb, Mo, Hf, Ta, and W).

Item 4: The lithium ion secondary battery recited in any one of items 1 to 3, wherein, when a total amount of the negative electrode active material is treated as 100 mass %, a containing ratio of a Si element in the negative electrode active material is equal to or more than 5 mass % and not more than 10 mass %.

Item 5: The lithium ion secondary battery recited in any one of items 1 to 4, wherein the negative electrode further contains a negative electrode current collector, the negative electrode active material layer, viewed in a thickness direction, comprises a negative electrode lower layer coming into contact with the negative electrode current collector, and comprises a negative electrode upper layer apart from the negative electrode current collector more than the negative electrode lower layer, and when a Si element of a whole of the negative electrode active material is treated as 100 mass %, the containing ratio of the Si element of the negative electrode upper layer is equal to or more than 90 mass %.

Item 6: The lithium ion secondary battery recited in item 5, wherein a ratio of a thickness of the negative electrode upper layer with respect to a whole thickness of the negative electrode active material layer is equal to or more than 0.4 and not more than 0.8.

Item 7: The lithium ion secondary battery recited in any one of items 1 to 6, wherein the Si containing material contains 1 or more kinds selected from Si, silicon oxide, and a Si—C composite.

What is claimed is:

1. A lithium ion secondary battery, comprising:
a positive electrode;
a negative electrode;
a separator; and
a nonaqueous electrolyte, wherein
the positive electrode comprises a positive electrode active material layer that contains a positive electrode active material,
the positive electrode active material is a lithium-transition metal complex oxide that contains Li, Ni, and Mn and that has a layered structure,
on the lithium-transition metal complex oxide, a containing rate of the Ni is equal to or more than 75 mol % with respect to a total of metal elements other than the Li,
the negative electrode comprises a negative electrode active material layer that contains a negative electrode active material,
the negative electrode active material contains a carbon material and a Si containing material, and
in the positive electrode active material, a containing rate (mol) of a Co element and a containing rate (mol) of a Mn element satisfy a following relation:
$$0 \leq Co / Mn \underline{<} 0.43 .$$

2. The lithium ion secondary battery according to claim 1, wherein
in the positive electrode active material, a content amount (mol) of the Co element and a content amount (mol) of the Mn element satisfy a below described relation:
$$0 \leq Co / Mn \underline{<} 0.3 2 .$$

3. The lithium ion secondary battery according to claim 1, wherein
the positive electrode active material is represented by a following general chemical formula:
Li_{α}NiₓMn_{y}M_{z}O₂
(incidentally, 0.8≤α≤1.2, 0.75≤x≤0.95, 0.05≤y≤0.25, 0≤z≤0.2, x+y+z=1, and M is equal to or more than 1 kind selected from Mg, Ca, Co, Al, Ti, V, Cr, Zr, Nb, Mo, Hf, Ta, and W).

4. The lithium ion secondary battery according to claim 1, wherein
when a total amount of the negative electrode active material is treated as 100 mass %, a containing ratio of a Si element in the negative electrode active material is equal to or more than 5 mass % and not more than 10 mass %.

5. The lithium ion secondary battery according to claim 1, wherein
the negative electrode further contains a negative electrode current collector,
the negative electrode active material layer, viewed in a thickness direction, comprises a negative electrode lower layer coming into contact with the negative electrode current collector, and comprises a negative electrode upper layer apart from the negative electrode current collector more than the negative electrode lower layer, and
when the Si element of a whole of the negative electrode active material is treated as 100 mass %, the containing ratio of the Si element of the negative electrode upper layer is equal to or more than 90 mass %.

6. The lithium ion secondary battery according to claim 5, wherein
a ratio of a thickness of the negative electrode upper layer with respect to a whole thickness of the negative electrode active material layer is equal to or more than 0.4 and not more than 0.8.

7. The lithium ion secondary battery according to claim 1, wherein
the Si containing material contains 1 or more kinds selected from Si, silicon oxide, and a Si—C composite.
